(19) United States
(12) Patent Application Publication
(10) Pub. No.: US 2011/0150050 A1
(43) Pub. Date: Jun. 23, 2011

(54) DIGITAL INTEGRATED ANTENNA ARRAY FOR ENHANCING COVERAGE AND CAPACITY OF A WIRELESS NETWORK

(76) Inventors: Hafedh TRIGUI, Ottawa (CA); Richard Duncan Cuthill, Reston, VA (US)

(21) Appl. No.: 12/645,966

(22) Filed: Dec. 23, 2009

(51) Int. Cl. H04L 5/16; H04K 1/10

(52) U.S. Cl. 375/219; 375/260

(57) ABSTRACT

An embodiment of the invention relates to a digital integrated antenna array system having one or more antenna modules, one or more transceiver modules each having one or more signal processing paths for transmitting data to or receiving data from the one or more antenna modules, a signal processing unit able to process data for each the one or more signal processing paths of the one or more transceiver modules such that the data transmitted from the one or more transceiver modules to the one or more antenna modules is radiated by the one or more antenna modules into one or more radiation patterns.

### BACKGROUND OF THE INVENTION

1. Field of the Invention

The present invention relates generally to the field of wireless networking, and more specifically to using a digital integrated antenna array for enhancing coverage and capacity of a wireless network, and enabling a versatile solution for sharing antenna elements and active electronics between multiple operators servicing the same geographic area regardless of the supported base stations' multi-antenna schemes and the number of RF carriers.

2. Description of the Related Art

A key factor in network design is the cost per bit of transmitted data. Ideally, the cost per bit is reduced to cope with increase in demand of data rates while keeping unchanged customers' subscription fees. A partial solution to this problem comes from adopting the most spectrally efficient air interface (for example, orthogonal frequency-division multiplexing (OFDM)), and multiple input multiple output (MIMO) antenna techniques by an advanced wireless system such as WiMAX or 3^{rd} Generation Partnership Project Long Term Evolution (3GPP LTE).

FIGS. 1A-1D illustrate conventional approaches to reduce radio frequency (“RF”) losses and enable versatile capacity and network level optimization solutions using a remote radio head (“RRH”) implementing a 2×2 MIMO system. FIG. 1A illustrates a general high-level implementation of the conventional systems, while FIGS. 1B-1D illustrate alternate conventional systems using similar approaches to that of FIG. 1A.

In FIG. 1A, a single modem 104 is connected via a fiber optic interface 101 to an RRH 100. Additionally, the RRH 100 is connected to a passive antenna array 102 for transmitting/receiving RF signals. The RRH 100 has a digital interface core 106 for handling signals as specified by Open Base Station Architecture Initiative (“OBSAI”), Common Protocol Radio Interface (“CPRI”), or other propriety digital interfaces.

Signals to be transmitted by the passive antenna array 102 are passed through a circuit 110 for converting the signals from baseband to RF, and then passed through a power amplifier 114. The power amplifier 114 is connected to the digital interface core 106 via a closed loop control module 118 in which the transmission signal is monitored and altered to compensate for inter-modulation products and reducing spectral emission spikes to comply with government regulations. The transmission signal is passed through the power amplifier 114 to a diplexer 116 before being transmitted by the passive antenna array 102.

Signals received by the passive antenna array 102 are passed through the diplexer 116 before entering a low-noise amplifier 112. The received signals are then passed through a circuit 108 for converting RF to baseband, and passed to the digital interface core 106 before being transmitted via the fiber optic interface 101 to the single modem 104.

FIG. 1A illustrates a 2×2 MIMO system in which the pair of transmission/reception paths are multiplexed and, as a result, serviced by a single fiber optic cable 101 from the modem 104 to the RRH 100. In the transmit direction, the digital signals received from the modem 104 are de-multiplexed, converted to RF, routed to the two power amplifiers 114, and finally to the passive antenna array 102. Received digital streams along the two reception paths are multiplexed before being transmitted via the optical fiber cable 101 to the modem 104.

Additionally, FIG. 1A illustrate a control module 118 for closed loop power control of each power amplifier and other functions such as setting digital gains and other register values, as well, as monitoring the temperature and health of key hardware components. Control messages for the two transceivers are extracted from the single digital interface core 106. A single digital interface core 106 is used because the information and control data for the two signal paths are multiplexed into the core 106.

FIG. 1B illustrates a 2×2 MIMO system in which each transmission/reception path is serviced by its own digital interface core 106 in the RRH 120. Additionally, each transceiver path has its own control and monitoring function 118. Moreover, control is not limited to closed loop power control but also setting up some basic RF parameters such as digital gains and other register values as well as monitoring the health, failure and temperature of key hardware components. Additionally, each of the digital interface cores 106 are connected to a modem 104 via a separate fiber optic interface 101 as the two data paths are not multiplexed.

FIG. 1C illustrates a 2×2 MIMO system in which each transmission/reception path has its own digital interface core 106, however control signals are passed through one of the digital interface cores to the two transceivers of the RRH 140.

FIG. 1D illustrates a 2×2 MIMO system for transmitting/receiving multiplexed signals and it is simply a more detailed version of FIG. 1A to better explain multiplexing and de-multiplexing of the transmit and receive digital signals as well as the control signals for the two transceivers of the RRH.

Additionally, co-channel interference avoidance and/or reduction is recommended to improve spectrum efficiency. Typical interference cancellation algorithms are implemented at baseband for each active user while interference avoidance is implemented in the MAC layer and uses some sort of collaboration between multiple sectors. It is known that perfect cancellation of interfering signals may be possible in the uplink, and only a reduction of probability of interference occurrence in the downlink is possible, which is implemented by means of beamforming which implies the deployment of antenna arrays.

Beamforming is a general signal processing technique used to control the directionality of the reception or transmission of a signal on a transducer array. Using beamforming, the majority of signal energy can be transmitted from a group of transducers (such as radio antenna) in a chosen angular direction.

Obviously, per user beamforming requires the development of more expensive base stations that provide meaningful business only in specific cases. The reality is that conventional base stations will continue to be deployed in a large portion of a network. Therefore, sub-sectorization becomes a faster and more economical hotspot solution addressing the unbalanced traffic demand across the network.

Sub-sectorization uses the antenna array to create sub-sectors with specified radiation patterns to serve a desired number of subscribers. Sub-sectors are developed based on analysis of traffic patterns for an area and antenna parameters, such as azimuth beamwidth, azimuth direction, and tilt value, are adjusted accordingly. For example, a tri-sector site may simply be upgraded to 4, 5, 6 or more sectors as required by traffic increase demand over deployment time without any change to the base station apart from adding base band channel cards. Sub-sectorization capacity benefits have been recognized for WiMAX and UMTS, respectively.

Apart from sub-sectorization coverage and capacity benefits, digital integrated antenna arrays (DIAA) improve the reliability of the radio access system by distributing the total power across multiple devices operating at lower temperature and therefore experiencing higher mean time between failures (MTBF). Additionally, the distributed design allows the digital integrated antenna system to operate indefinitely in a soft-failure mode where the remaining transceivers compensate for any degradation in the radiation patterns if one or more transceivers fail. The soft-failure feature alone provides significant benefits to service providers since there is no urgency in replacing the DIAA as a result of a single or limited number of failures.

While sub-sectorization solves the capacity problem on average, there is a desire for dynamically changing the coverage area of the sectors so that traffic is balanced most of the time, therefore providing all subscribers with the best possible performance.

### SUMMARY OF THE INVENTION

In order to solve the above-noted deficiency in the art, it is proposed to integrate a passive antenna array with radio transceivers in a single physical package and to distribute the design to increase the degrees of freedom to offer more control flexibility.

An embodiment of the invention relates to a digital integrated antenna array system having one or more antenna modules, one or more transceiver modules each having one or more signal processing paths for transmitting data to or receiving data from the one or more antenna modules, and a signal processing unit able to process data for each the one or more signal processing paths of the one or more transceiver modules such that the data transmitted from the one or more transceiver modules to the one or more antenna modules is radiated by the one or more antenna modules into one or more radiation patterns.

### BRIEF DESCRIPTION OF THE DRAWINGS

FIGS. 1A-1D illustrate conventional circuit designs to reduce RF losses and enable versatile capacity and network level optimization solutions using an RRH implementing a 2×2 MIMO system.

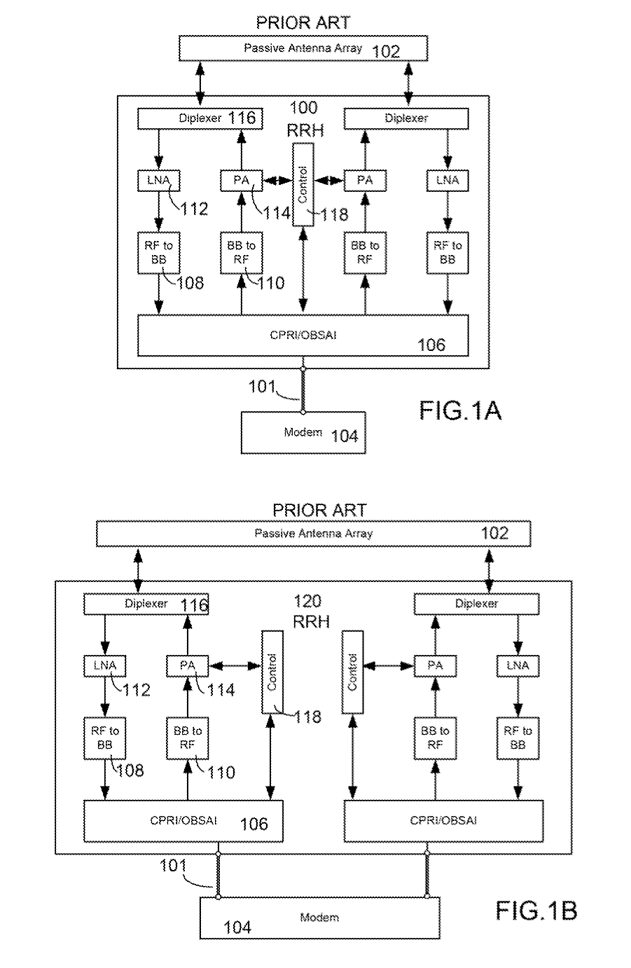

FIG. 2A illustrates an exemplary high-level implementation of a single MIMO branch of a digital integrated antenna array system in accordance with an embodiment of the present invention.

FIG. 2B illustrates a more detailed implementation of the DIAA of FIG. 2A.

FIG. 3A and FIG. 3B illustrate two exemplary frequency allocations in a two operator system of subsector signals in accordance with an embodiment of the present invention.

FIG. 4A and FIG. 4B illustrate exemplary beam patterns of broadcast subsector signals of multiple operators based on the frequency allocation of FIG. 3A.

FIG. 4C and FIG. 4D illustrate exemplary beam patterns of broadcast subsector signals of multiple operators based on the frequency allocation of FIG. 3A.

FIG. 5A and FIG. 5B illustrate two examples of power allocation to a beam pattern of three broadcast subsector signals for a single operator in accordance with an embodiment of the present invention.

FIG. 6 illustrates an exemplary digital integrated antenna array system for carrying out an alternate embodiment of the present invention.

FIG. 7 illustrates an exemplary digital integrated antenna array system for carrying out an alternate embodiment of the present invention.

FIG. 8 illustrates an exemplary digital integrated antenna array system for carrying out an alternate embodiment of the present invention.

FIG. 9 illustrates an exemplary digital integrated antenna array system for carrying out an alternate embodiment of the present invention.

FIG. 10 illustrates an exemplary digital integrated antenna array system for carrying out an alternate embodiment of the present invention.

FIG. 11 illustrates an exemplary digital integrated antenna array system for carrying out an alternate embodiment of the present invention.

FIG. 12 is a representative Beamforming and Translation module for calibrating multiple signal processing paths as shown in the system of FIG. 2A.

### DETAILED DESCRIPTION OF THE INVENTION

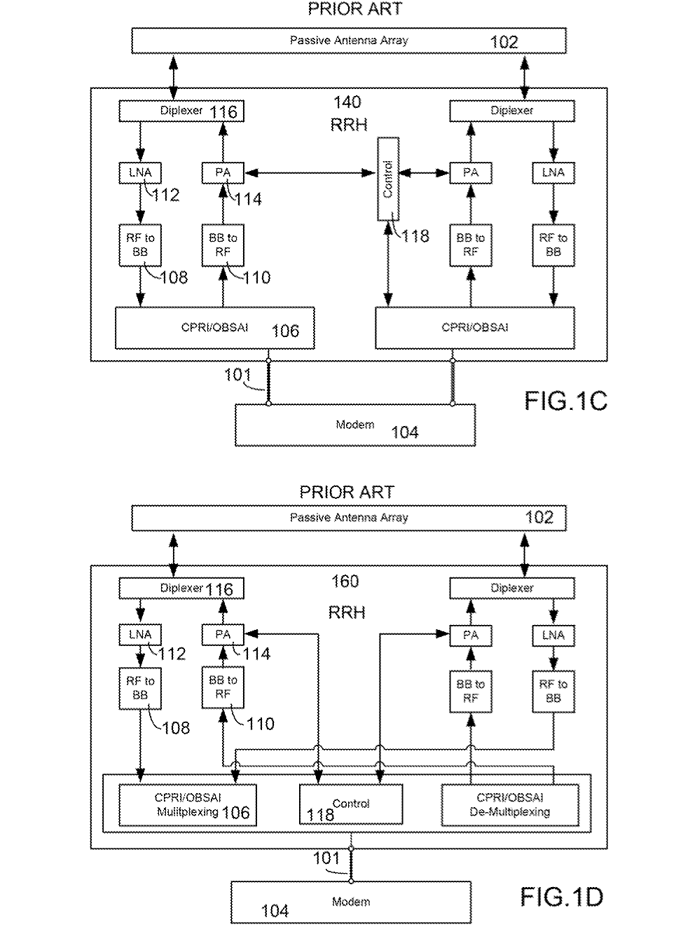

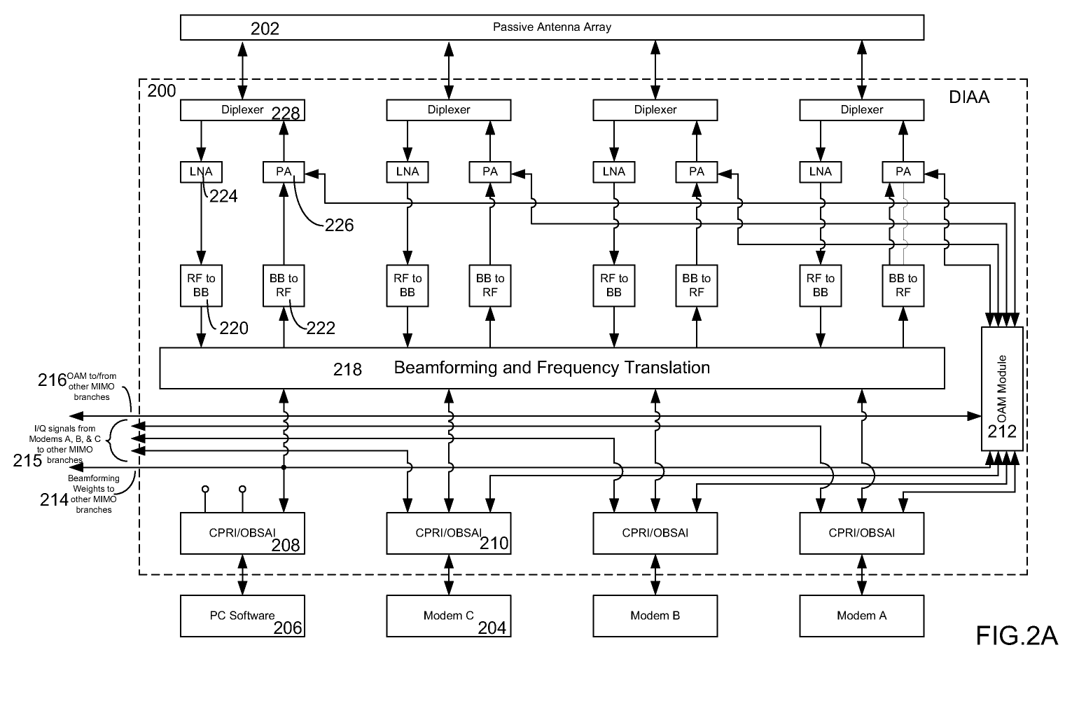

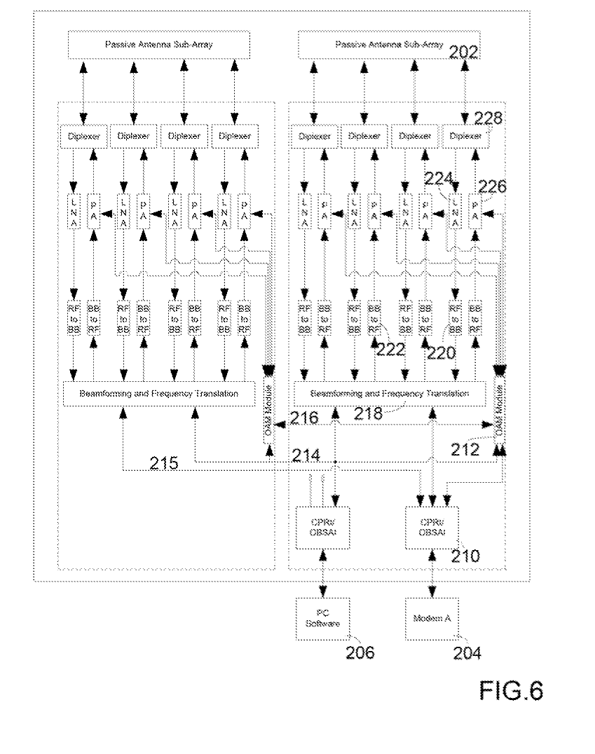

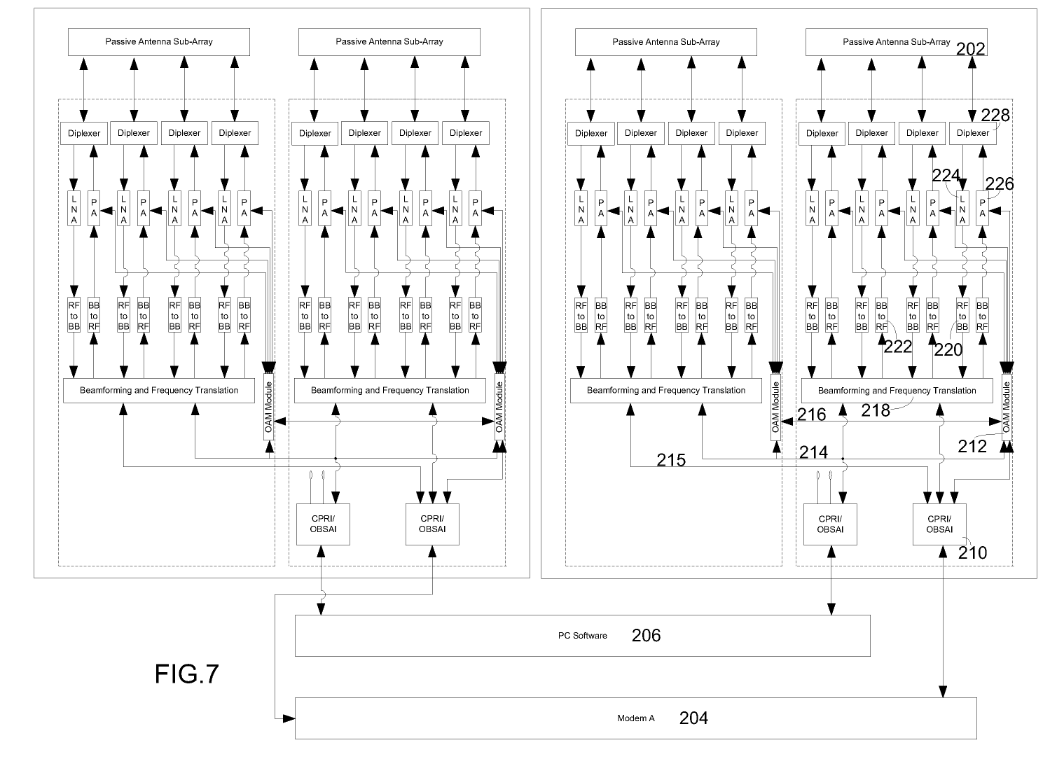

FIGS. 2A and 2B illustrate an exemplary digital integrated antenna array system for carrying out an embodiment of the present invention. FIG. 2A illustrates a general high-level implementation of the digital integrated antenna array (“DIAA”) and represents a single MIMO branch of a DIAA system, while FIG. 2B shows a more detailed implementation of the DIAA of FIG. 2A. An exemplary implementation of a 2×N MIMO DIAA, essentially including multiples of the hardware of FIGS. 2A and 2B, is illustrated FIG. 6 and will be discussed below. Additionally, exemplary implementations of 4×N MIMO DIAAs, essentially including multiples of the hardware of FIGS. 2A and 2B, are illustrated by FIGS. 7-11 and will be discussed below. In discussing a 2×N or a 4×N system DIAA, it should be noted that N is the number of transceivers at the subscriber station, a detailed discussion of which is outside the scope of the present application.

In FIG. 2A, one or more modems 204, such as, for example, baseband modules of cellular base stations, are connected via one or more fiber optic interfaces, respectively, to one or more digital interface cores 208, 210 within the DIAA 200. The one or more digital interface cores 208, 210 are used to handle signals as specified by Open Base Station Architecture Initiative (“OBSAI”), Common Protocol Radio Interface (“CPRI”), or other propriety digital interfaces. Each digital interface core is able to multiplex the multi-antenna signals, if applicable, and extract messages to control and monitor specific hardware components or registers which are then relayed to an operation and maintenance (“OAM”) module 212.

In this embodiment, one of the digital interface cores 208 is connected via a fiber optic interface or Ethernet or the like to a server based software interface 206. The server based software is used to control the DIAA 200 allowing a user to define any shape of radiation pattern for the passive antenna array 202 via a graphical user interface or entering key parameters such as azimuth pointing direction, azimuth beamwidth, side-lobes level, electrical tilt, RF frequency, and antenna type. The server based software calculates the ideal beamforming weights 214 that best approximate the desired radiation pattern and the weights are passed to the DIAA 200. Beamforming weights are computed and provided to the DIAA 200 to improve the performance of the wireless network by improving coverage and quality, and increasing capacity, or the like.

It should be noted that the server based software may be operated in manual mode as described above, or in automatic mode in which specific sets of weights are applied at different times in the day, month, season, or year, or triggered by different calendar events, such as sporting events or music events, or the like. Further, the server based software can be equipped with a real-time optimization module that dynamically adjusts the radiation patterns to improve coverage and capacity without need for human intervention or a fixed schedule.

Additionally, the server based software may be used to gather alarm data from the DIAA 200 for any failure or near failure of key components (such as components operating at temperatures close to maximum specified values) such that a user may make an appropriate decision regarding use of the DIAA 200. For example, a user may decide to lower the power supplied to the DIAA 200 if it would lower the temperature inside the DIAA 200. In the case of a power amplifier failure along one of the transmission paths, the server based software 206 is able to re-adjust the beamforming weights 214 such that the best possible radiation pattern is obtained for the remaining power amplifiers to continue covering the same area. Although not shown, it should be noted that directional couplers between the passive antenna array 202 and the low-noise amplifies 224 or the power amplifiers 226 may be used to obtain transmission/reception calibration data in order to create transmission/reception calibration weights to be added to each of the modem signals in order to calibrate the DIAA 200 as required for digital beamforming. However, it should be clear that calibration weights for transmitting and receiving are only derived from operational transceivers in case one or more of the transceivers fail.

Although FIG. 2A illustrates only a single MIMO branch DIAA, the present invention contemplates the use of multiple MIMO branches (as will be illustrated below with references to FIGS. 6-11). As such, signals 216 from the OAM module 212 can be sent to/received from OAM modules of other MIMO branches. Similarly, I/Q signals 215 from any of the modems, as well as the beamforming weights 214, can be sent to other MIMO branches.

Although FIG. 2A shows a server based software interface 206 for the DIAA 200, it should be noted that the beamforming software could reside in the DIAA itself or in existing network management system controlling the RNC, BS, etc, and, therefore, the beamforming weights would be passed along one or more modems 204 to the digital interface cores 210.

When using the DIAA 200 for beam shaping and/or high-order sub-sectorization, it is noted that when dealing with clusters of subscribers, rather than individual subscribers, the rate of changing the beamforming weights can be slow (15 minutes or more). However, if a particular application requires faster changing of beamforming weights, the DIAA 200 may be configured such that discrete sets of beamforming weights are stored in memory and could simply pass an index through the OBSAI/CPRI 208 or Ethernet link 206.

After processing by the digital interface cores 208, 210, each of the modem signals are transmitted to the beamforming and frequency translation module 218 where the signals are frequency shifted and split into a number of signals equal to the number of transceiver paths of the DIAA 200. FIG. 2A illustrates a system having four digital interface cores 208, 210 and four transceiver paths; however, it should be apparent to one of ordinary skill in the art that alternative numbers of each may be used. Each set of the modem signals, after split, is multiplied by the beamforming and calibration weights such that when applied to the passive antenna array 202, a user-specified radiation pattern is formed; the user-specified radiation pattern may have one or more subsector radiation patterns.

After processing in the beamforming and frequency module 218, each of the modem signals along the transceiver paths are passed though a circuit 220 for converting the baseband signals to RF signals and then passed through a power amplifier 226. The power amplifier is connected to an OAM module 212 and a feedback loop for power control and compensating for inter-modulation products, as well as, reducing spectral emission spikes to comply with government regulations. Output from the power amplifiers 226 is passed through a diplexer 228 before being transmitted to the passive antenna array 202.

In the receive direction, signals from the passive antenna array 202 are passed through the diplexer 228 before entering a low-noise amplifier 224. Output signals from the low-noise amplifiers 224 are converted from RF to baseband by a circuit 220 before being fed to the beamforming and frequency translation module 218 where beamforming and calibration weights are applied to the received signals to form modem signals. Each of the modem signals are then filtered and extracted before passing through the digital interface cores 208 210 to the modems 204 and server based software interface 206.

Additionally, it should be readily apparent to one of ordinary skill in the art that the above-described system can be modified to be applied to communication networks as necessary to achieve integration, i.e., the above-described system can, for example, be used in a time-division duplex communication network or a frequency division duplex communication network.

An additional feature of the present invention is enabling multiple operator sharing of a passive antenna array, transceivers, and the total available power of the DIAA. Additionally, splitting resources between the multiple operators is flexible and should be done on the basis of the individual operator needs.

In FIG. 2B, a digital board 250 interfaces with dual front-end modules (“DFEMs”) 252 and baseband modules of basestations (not shown) through OBSAI/CPRI cores 210 residing on the digital board. In addition to the OBSAI/CPRI cores 210, signal converters and their associated circuitry, and signal processing circuitry reside on the digital board. The signal processing circuitry may be implemented using a field programmable gate array (“FPGA”). The DFEMs 252 mainly contain power amplifiers (“PAs”) 226 and low-noise amplifiers (“LNAs”) 224 and some supporting circuitry, which enables conversion of the signals from radio frequency (RF) to intermediate frequency (IF) and vice versa. While FIG. 2B illustrates DFEMs 252, it should be noted that it is not necessary to group the circuitry residing in the DFEMs 252 into two modules, and that the DFEMs 252 illustrated in FIG. 2B could be broken up into multiple front end modules to accomplish the same objective or combined into a single front end module.

The DFEMs 252 are attached to a radio-frequency filter 254, which passes wanted signals while attenuating unwanted signals to/from antenna arrays 256. The antenna arrays 256 may consist of sub-arrays where the antenna elements of each sub-array are combined passively to achieve a predefined pattern. Ideally, the antenna array elements are closely spaced to avoid grating lobes when steering a beam off boresight direction.

Additionally, FIG. 2B illustrates the system for use in a time division duplex (“TDD”) scheme, as such, at the output of the DFEMs 252, a transmit and receive (“t/r”) switch is connected to control the output of the DFEMs 252. While not shown, it should obvious to one of ordinary skill in the art that the system can be readily modified for use in a frequency division duplex (“FDD”) scheme by substituting the t/r switch with a diplexer enabling the antenna array 256 to transmit and receive at the same time but on different frequency bands.

In FIG. 2B, six OBSAI/CPRI cores 210 are used to correspond to 6 distinct modem signals. Each core is able to handle one or more signals as specified in the OBSAI, CPRI, or base station vendor standards. The cores will de-multiplex the multi-antenna signals, if applicable, and extract specific messages to control and monitor specific hardware components and/or registers. Each modem signal is then frequency shifted before being fed into a beamforming core 218 where the modem signal is split into a number of signals equal to the number of transceivers in the DIAA (FIG. 2B shows 4 transceivers). Additionally, in the beamforming core 218, each branch of the modem signal is multiplied by a complex-valued number such that when applied to the antenna array, along with the other branches of the modem signal, a specified radiation pattern is formed.

Further, apart from complex weighting branch signals of the same modem, the beamforming core 218 sums, for each branch, weighted signals from multiple modems. The composite signal will be subject to crest factor reduction (“CFR”) for a first attempt of reducing the peak to average ratio resulting in a better output power. A closed loop power control and digital pre-distortion (DPD) algorithm then compensates for inter-modulating products and reduces spectral emission spikes to comply with government regulations on broadcast signals. Feedback for this operation is taken after the power amplifier 226 in each of the transceiver paths.

In the receive direction, output signals from the LNA 224 of each transceiver are digitized and fed into the beamforming core 218 where modem-specific beamforming weights are used to combine the composite transceiver signals into modem signals. Each of the modem signals are then filtered and extracted before passing the respective OBSAI/CPRI core 210 to the baseband modules of the basestation.

Generally speaking, transmit and receive beamforming weights for each modem are the same. However, the beamforming weights could be different in some circumstances such as a failed power amplifier within a transceiver while the LNA of the same transceiver is still functioning properly. In such a case, as applied to the illustration of FIG. 2B, there will be three complex weights for transmit and four complex weights for receive, thereby, resulting in different radiation patterns.

Direction couplers shown between the antenna array 256 and the RF filters 254 are used to calibrate the hardware as required for digital beamforming. The detailed description of which is beyond the scope of the present application.

In the event of a modem or an optical link failure causing a downgrade, the DIAA is capable of adjusting the beamforming weights such that the same area will be covered with a reduced number of modems. For example, if the DIAA was broadcasting three beams at 30°, 60°, and 30°, half power beamwidth respectively, and a total failure occurred for the modem controlling the middle beam; the DIAA could reconfigure the remaining beams as 60° and 60° beams, respectively, such that the same coverage area is maintained.

In a case where the DIAA is used as a substitute for the prior art remote radio heads (“RRH”), there is no requirements of changing basestation control signals by implementing an OAM abstraction layer. Such an implementation is called appliqué, as it does not require any development from the basestation side. In such an implementation, a modem connected to the DIAA will not see the hardware as was the case when the modem was connected to an RRH; therefore, it should be noted that the modem will not be able to perform operations such as setting transmit and receive RF frequency, transmit power, and switching on and off transceivers. Additionally, in this configuration, it is also not possible to send transceiver alarms and measurements to the modem because the mapping is no longer one to one; for example, FIG. 2B shows a mapping of six modems to four transceivers. In order to compensate for the above, the server-based software or alternatively the OAM emulation/translation function of the embedded software implemented in the DIAA gathers all the settings that are normally transmitted to the RRH and calculates equivalent settings to be applied to the DIAA transceivers. In the reverse direction, the server-based software or alternatively the OAM emulation/translation function of the embedded software implemented in the DIAA collects all the alarms and measurements from the transceivers, which are then converted into an equivalent set of signals that are understood by the modems, and transferred to the modems.

Alternatively, the abstraction layer could be implemented with modifications in the existing server-based software that recognizes the DIAA for a number of connected modems. This allows the DIAA to be integrated into the radio access network (“RAN”) rather than deployed as an appliqué system. However, in such an implementation, there would be no changes in functionality or performance over the RRH.

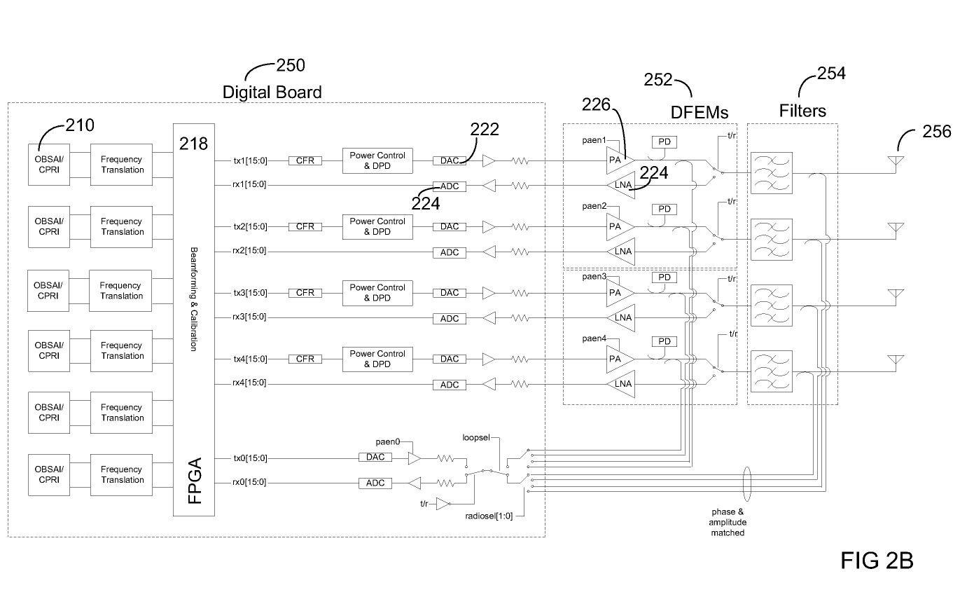

FIG. 3A and FIG. 3B illustrate two exemplary frequency allocations in a two operator system showing the flexibility of the present invention in frequency allocation of subsector signals. In FIG. 3A, a frequency allocation 300 for Operator 1 314 and Operator 2 316 are shown. In this frequency allocation 300, Operator 1 broadcasts subsector signals A 302, B 304, and C 306, and Operator 2 broadcasts subsector signals D 308, E 310, and F 312. FIG. 3B illustrates a second possible frequency allocation 318 in which Operator 1 314 broadcasts subsector signals A 302, C 306, and D 308, and Operator 2 316 broadcasts subsector signals B 306, E 310, and F 312. While FIG. 3A and FIG. 3B illustrate Operator 1 314 and Operator 2 316 broadcasting subsector signals in MIMO mode, it should be noted that configurations with single input single output (SISO) or mixed SISO/MIMO modes can be implemented by the present invention. Further, Operator 1 314 and Operator 2 316 could operate different radio access technologies (RAT) in the case the operators coexist within the frequency bandwidth as the present invention is RAT agnostic.

Additionally, while FIGS. 6-11 illustrate embodiments of the present invention as 2×N MIMO and 4×N MIMO, the DIAAs of FIGS. 6-11 may be configured such that single input single output (SISO) or mixed SISO/MIMO modes can be implemented.

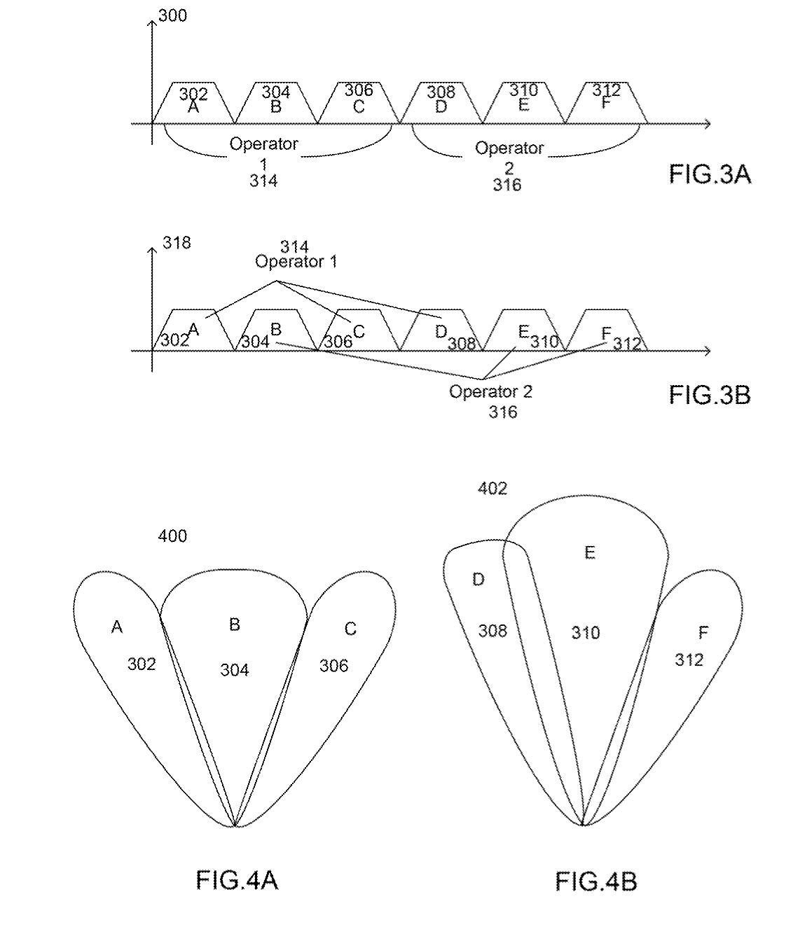

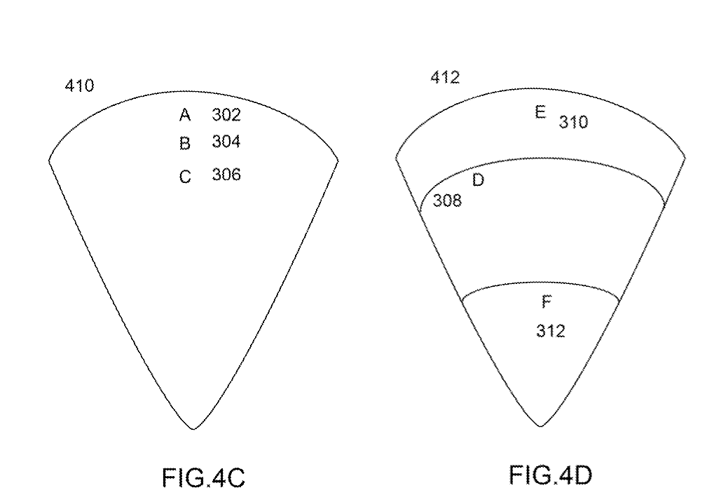

FIG. 4A and FIG. 4B illustrate possible beam patterns 400 402 of the broadcast subsector signals of Operator 1 314 and Operator 2 316, respectively, based on the frequency allocation 300 of FIG. 3A. While shown as separate beam patterns, it should be noted that beam patterns 400 and 402 are able to propagate over the same region and overlap each other, therefore enabling sharing of a passive antenna, transceivers, and the total power of the DIAA.

FIG. 4C and FIG. 4D illustrate another possible beam patterns 410 412 of the broadcast subsector signals of Operator 1 314 and Operator 2 316, respectively, based on the frequency allocation 300 of FIG. 3A. While shown as separate beam patterns, it should be noted that beam patterns are able to propagate over the same region and overlap each other, therefore enabling sharing of a passive antenna, transceivers, and the total power of the DIAA. As an example, FIG. 4C may correspond to a first operator that would like the three carriers A 302, B 304, and C 306 to have the same coverage while the second operator would like to have different coverage areas for his carriers D 308, E 310, and F 312. An exemplary realization of the coverage area of FIG. 4C and FIG. 4D could be FIG. 6 where each sub-array is allocated to one operator and beamforming is done in the vertical direction. The variation in coverage areas of FIG. 4D could be done by changing the tilt value for each RF carrier (D 308, E 310, and F 312) and/or with different transmit power levels to those RF carriers. Therefore the DIAA, when the building block of FIG. 2A is applied to sub-arrays in the vertical dimension, looks like a package of multiple remote electrical tilt antennas (“RET”) that could be shared flexibly between many operators. It should be clear to one of ordinary skill in the art that FIGS. 7-11, when the basic building block of FIG. 2A is applied to the vertical dimension, produce a plurality of RET antennas that could be flexibly shared between operators.

It should be noted that the total power of the DIAA is finite and depends on the number of power amplifiers and their actual output power. The DIAA calculates the distribution of the total power of the system through a dynamic power allocation algorithm.

The dynamic power allocation algorithm takes into account a number of factors including but not limited to the following: the channel bandwidth for each modem such that the greater the channel bandwidth, the greater the required power to achieve constant coverage; beam-shaping of the beam pattern of each subsector such that a narrower beam will require less power to achieve a certain equivalent isotropically radiated power (EIRP) because of its higher antenna array gain, additionally putting too much stress on side-lobes of a beam pattern or creating a sharper roll-off between adjacent beams results in a non-uniform distribution of power and may decrease the likelihood of using the total power of the DIAA; target EIRP values for each sub-sector signal; and regulatory and/or operator EIRP limits.

If the dynamic power allocation algorithm is unable to produce an optimized solution based upon the above criteria, the algorithm requests the user to enter changes such as equal EIRP, reduce the entered EIRP, or the like, such that an optimized solution can be calculated.

The output of the dynamic power allocation algorithm is a single transmit power value per modem that will be used with the equivalent antenna gain for the subsector and other parameters to establish a standard link budget as if the modem is connected to a remote radio head and a passive antenna rather than the DIAA. Additionally, the dynamic power allocation algorithm provides the benefit that the server-based software outputs the transmit power per RF carrier and antenna gain per RF carrier, thereby allowing a user to quickly establish the link budget without extensive background in beamforming. The link budget is a prediction of the reach of each RF carrier that factors in site, spectrum, service type and equipment parameters.

In the case in which multiple operators share the DIAA, two possible power allocation strategies could be used: a finite amount of power could be allocated to each operator up-front such that the operator cannot exceed this amount of power; or optimal power allocation guaranteeing a quota for each operator but allowing the possibility of exceeding the quota in case another operator is not using its allocated amount.

Additionally, the DIAA, when controlled by the server-based software, is capable of providing new business opportunities for tower owners who currently rent space and, at best, provide the service of basic infrastructure to service providers. In this manner, the DIAA could function as a key enabling system element for the tower company to provide high value services to the service provider simply by investing in DIAA equipment, server-based control software, and low to medium skilled operational personnel. The tower company could purchase DIAA equipment, install the DIAA equipment, and rent coverage areas as needed by specific operators.

As mentioned above, the DIAA is capable of creating customized coverage areas per RF carrier and to allocate them to operators according to the operators' frequency spectrum. This allows the tower company the ability to decide to charge a service operator not only for coverage, but, for example, whether the coverage will support MIMO, how much control an operator has in adjustment of antenna parameters, what visualization tools an operator may have access to, or whether an operator can take advantage of advanced software features, such as closed loop adaptation of coverage.

The server-based software is capable of providing multiple access privileges for the tower owner, the individual operators and the operational staff of each operator (e.g., RF engineers, technicians, or the like). For example, privileges may be set such that only the tower owner can change the total power per operator or dedicate an entire antenna column to a specific operator.

The DIAA is capable of providing each service provider with total flexibility to tailor the provider's coverage areas to a given need at any time, despite tower owner constraints resulting from business agreements. Recognizing these capabilities of the server-based software, a billing system could be built around the possibility of sharing actual or virtual portions of the DIAA to operators; actual portions refers to physical components such as antenna columns, sub-arrays, polarizations, transceivers, and the like, while virtual portions refers to coverage areas that need a plurality of components to produce them without having dedicated physical connections, such as antenna ports for the specific coverage areas. For example, tower owners may benefit by implementing pay-as-you go billing schemes and/or other billing packages in renting coverage areas to service providers.

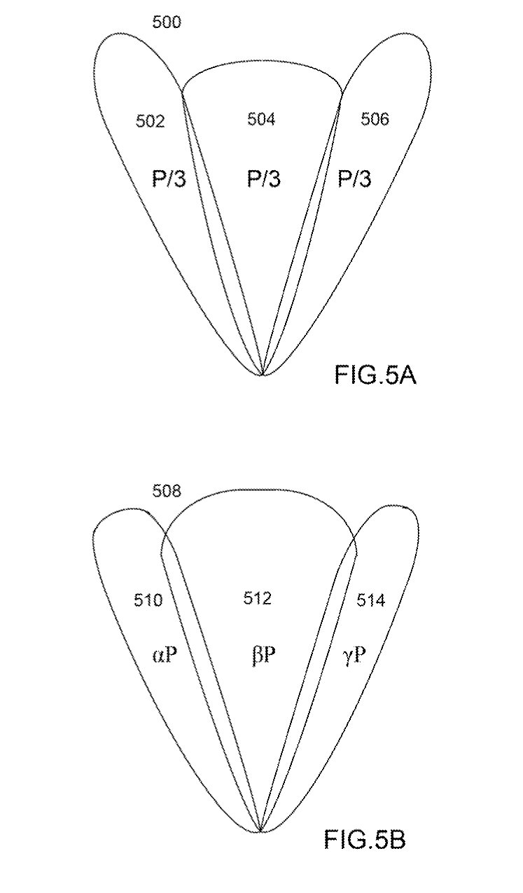

FIG. 5A and FIG. 5B illustrate two examples of power allocation to a beam pattern of three broadcast subsector signals for a single operator. FIG. 5A shows the total power of the system, P, is distributed equally to each of the subsector signals 502, 504, 506. This results in the wider subsector signal 504 having a reduced EIRP as compared to the narrow subsector signals 502, 506. FIG. 5B shows the total power of the system distributed to each of the subsector signals 510, 512, 514 in order to achieve a constant EIRP for all the subsector signals. Constant EIRP for all the subsector signals is achieved by the dynamic power allocation algorithm calculating α, β, and γ coefficients to maintain constant EIRP for all the subsector signals. In order to maximize the use of the total power of the system, P, the coefficients should be calculated such that α+β+γ=1. While not discussed, it should be obvious to one of ordinary skill in the art that alternative schemes could be implemented for forcing a wanted EIRP for each beam.

It should be noted that the DIAA is designed to comply with mobile WiMAX (IEEE802.16e), UMTS, and LTE base stations supporting space time transmit diversity (“STTD”) and spatial multiplexing (“SM”). Additionally, the present invention is designed to be flexible based on the desires and needs of original equipment manufacturers (“OEMs”) for LTE and future WiMAX standards (such as IEEE802.16m).

Additionally, the DIAA is not limited to deployment as a MIMO device and may be deployed to operate in SISO mode for UMTS. One such configuration could be achieved by using a single transceiver branch of the DIAA for transmission and multiple transceiver branches for reception.

Another configuration would be to use two transceiver branches to broadcast the same signal, however, one of the transceiver branches would transmit the signal with a deterministic time offset in order to artificially create multipath components that will be detected by user equipment and can be combined with the rack receiver to enhance the signal quality of the system.

In a case where the DIAA supports only two sectors with a similar number of carriers, a possible configuration would be to use a MIMO transceiver branch to transmit to a specific sector and two MIMO transceiver branches to receive from both sectors. In other words, each MIMO transceiver branch has one beam for transmit and receive, and a second beam for receive only.

In a case where the DIAA supports three sectors, it is preferable to distribute the carriers between the two branches evenly such that the power utilization of the system is maximized. In other words, a sector may have one carrier transmitted from a first transceiver branch and a second carrier transmitted from a second transceiver branch.

In a case of two operators sharing the DIAA and using MIMO and SISO configurations, respectively, it is preferable to split the carriers of the SISO configuration between two MIMO transceiver branches of the present invention to improve power utilization.

The flexibility of the DIAA is illustrated in FIGS. 6-11 as alternate embodiments of the DIAA as partially shown in FIG. 2A. Identical components to those described above with respect to FIG. 2 will not be described. It should be noted that the present invention is not limited to the alternate embodiments as shown in FIGS. 6-11, and it would be readily apparent to one of ordinary skill in the art that other alternative embodiments are possible depending on the specific needs of a user.

FIG. 6 illustrates a 2×N MIMO DIAA system. The operation of the components of the DIAA of FIG. 6 are similar to that already described above in reference to FIG. 2A, and, therefore, will not be repeated here. The primary difference between the DIAA of FIG. 6 and that of the other illustrated embodiments is that FIG. 6 illustrates two MIMO branches configured to provide a 2×N MIMO DIAA system. Additionally, the 2×N MIMO DIAA could be configured such that each antenna sub-array of FIG. 6 may provide a specified polarization as required by an application.

FIG. 7 illustrates a 4×N MIMO DIAA system. The operation of the components of the DIAA of FIG. 7 are similar to that already described above in reference to FIG. 2A, and, therefore, will not be repeated here. The primary difference between the DIAA of FIG. 7 and that of the other illustrated embodiments is that FIG. 7 illustrates a 4×N MIMO DIAA system implemented as two independent 2×N MIMO DIAAs such that communication between the two 2×N MIMO DIAAs is not necessary. Additionally, the two DIAAs may use two different passive antenna sub-arrays. As a result, the server-based software may control each DIAA independently from the other.

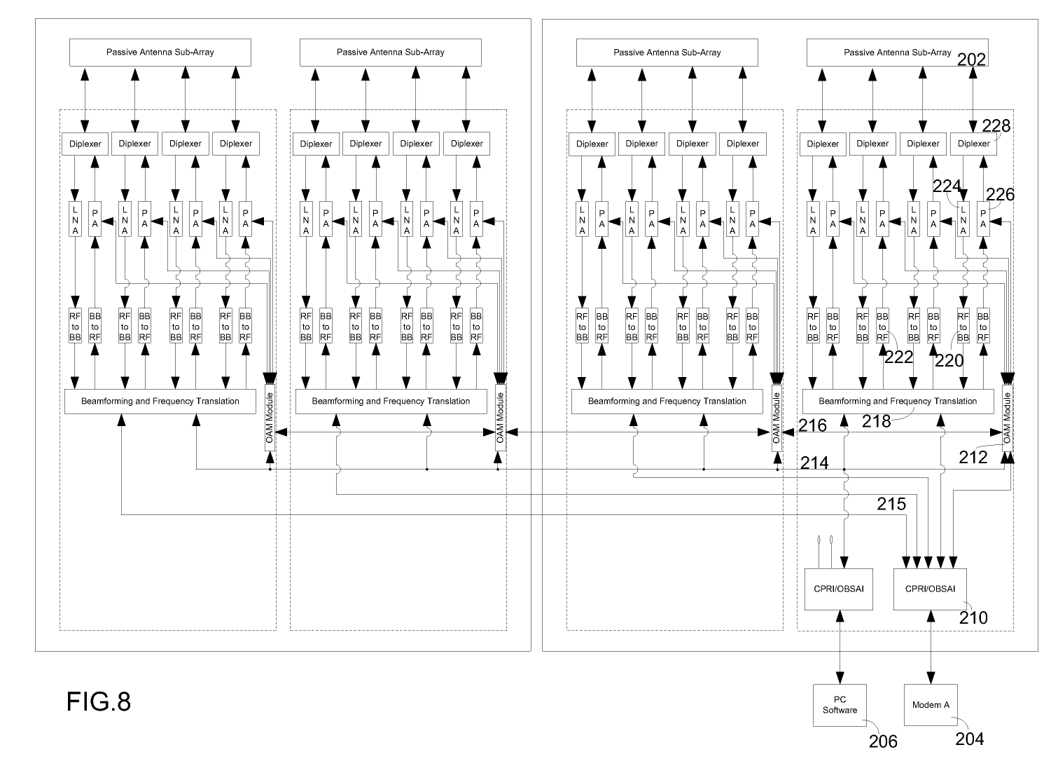

FIG. 8 illustrates a 4×N MIMO DIAA system. The operation of the components of the DIAA of FIG. 8 are similar to that already described above in reference to FIG. 2A, and, therefore, will not be repeated here. The primary difference between the DIAA of FIG. 8 and that of the other illustrated embodiments is that FIG. 8 illustrates a 4×N MIMO DIAA system in which communication between two 2×N MIMO DIAAs is established to pass necessary digital signals as well as control signals used to operate the 4×N MIMO DIAA system. It should be noted that in this configuration, the server-based software views one of the 2×N MIMO DIAAs as a primary branch, or master, and the other as a secondary branch, or slave.

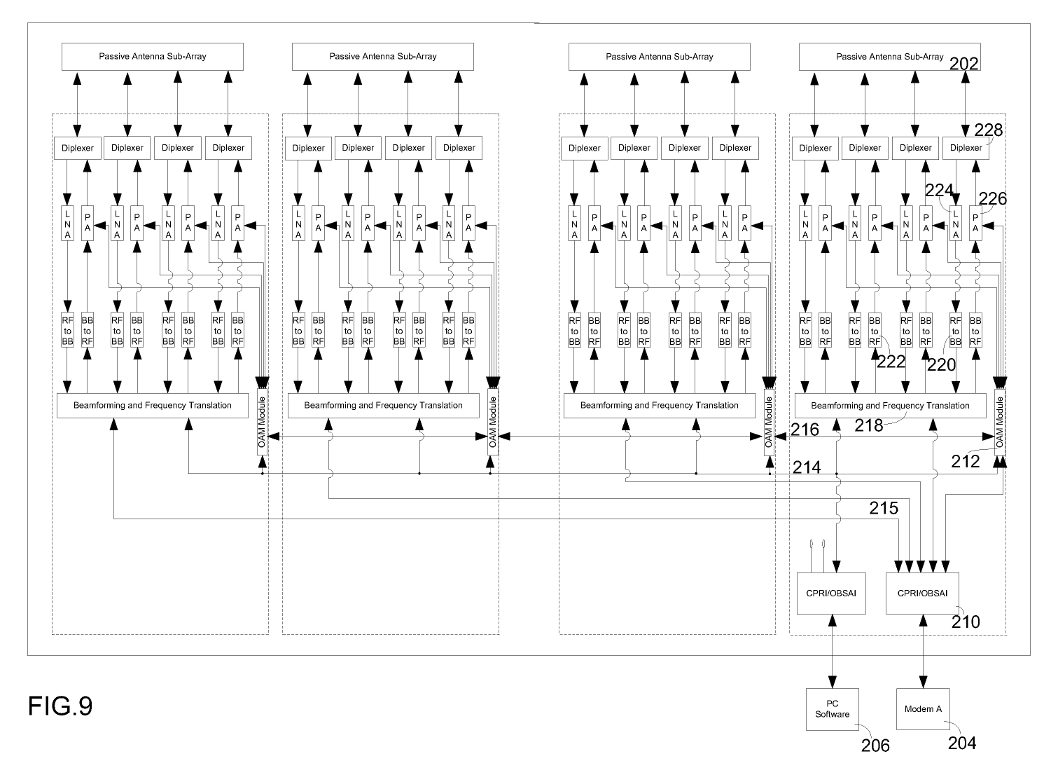

FIG. 9 illustrates a 4×N MIMO DIAA system. The operation of the components of the DIAA of FIG. 9 are similar to that already described above in reference to FIG. 2A, and, therefore, will not be repeated here. The primary difference between the DIAA of FIG. 9 and that of the other illustrated embodiments is that FIG. 9 illustrates a 4×N MIMO DIAA system in a single physical package. Specifically, the main design change over the 4×N MIMO DIAA of FIG. 8 is the implementation of the passive antenna sub-arrays. One possible way to alter the configuration is to migrate from a dual-poles antenna array to two dual-poles side by side as a means of providing four branches required by 4×N MIMO operation. Alternatively, it would be obvious to one of ordinary skill in the art that there are other possibilities to alter the configurations, for example, having four sub-arrays side by side but with alternate polarization.

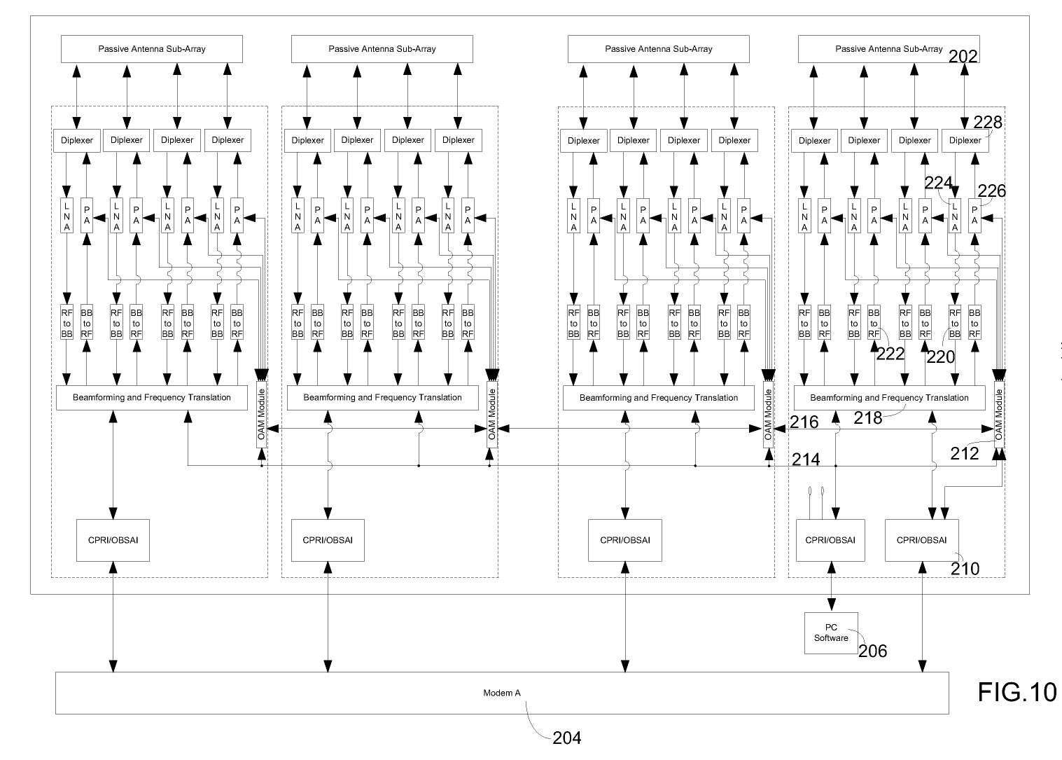

FIG. 10 illustrates a 4×N MIMO DIAA system. The operation of the components of the DIAA of FIG. 10 are similar to that already described above in reference to FIG. 2A, and, therefore, will not be repeated here. The primary difference between the DIAA of FIG. 10 and that of the other illustrated embodiments and is that FIG. 10 illustrates each MIMO branch having an OBSAI/CPRI core.

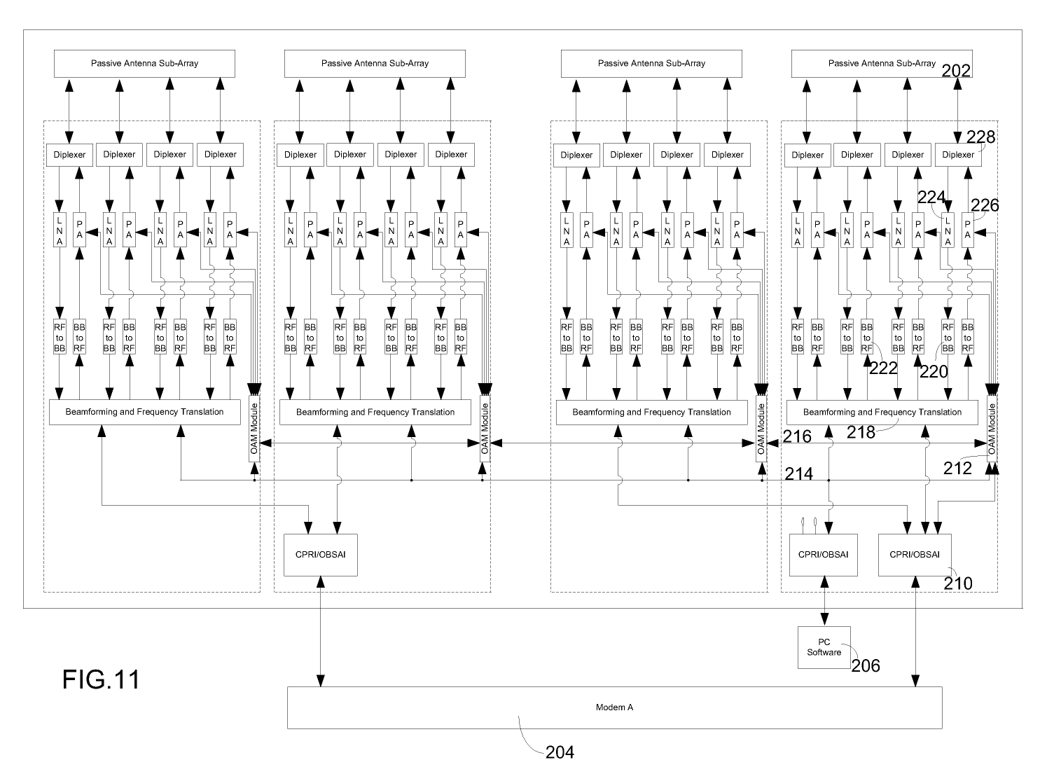

FIG. 11 illustrates a 4×N MIMO DIAA system. The operation of the components of the DIAA of FIG. 11 are similar to that already described above in reference to FIG. 2A, and, therefore, will not be repeated here. The primary difference between the DIAA of FIG. 11 and that of the other illustrated embodiments is that FIG. 11 illustrates an OBSAI/CPRI core per two MIMO branches and therefore requiring multiplexing and de-multiplexing at the OBSAI/CPRI cores.

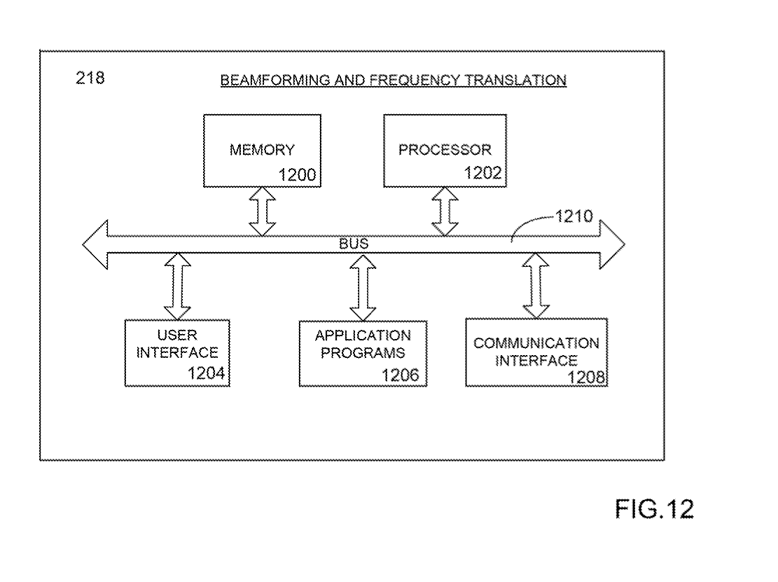

FIG. 12 is a representative Beamforming and Translation module 218 for calibrating multiple signal processing paths as shown in the system of FIG. 2A. In FIG. 12, the beamforming and translation module 218 includes a memory 1200, a processor 1202, user interface 1204, application programs 1206, communication interface 1208 and bus 1210.

The memory 1200 can be computer-readable media used to store executable instructions, computer programs, algorithms or the like thereon. The memory 1200 may include a read-only memory (ROM), random access memory (RAM), programmable read-only memory (PROM), erasable programmable read-only memory (EPROM), a smart card, a subscriber identity module (SIM), or any other medium from which a computing device can read executable instructions or a computer program. The term “computer programs” is intended to encompass an executable program that exists permanently or temporarily on any computer-readable medium. The instructions, computer programs and algorithms stored in the memory 1200 cause the beamforming and translation module 218 to perform calibrating multiple signal processing paths as described in the system of FIG. 2A. The instructions, computer programs and algorithms stored in the memory 1200 are executable by one or more processors 1202, which may be facilitated by one or more of the application programs 1206.

The application programs 1206 may also include, but are not limited to, an operating system or any special computer program that manages the relationship between application software and any suitable variety of hardware that helps to make-up a computer system or computing environment of the beamforming and translation module 218. General communication between the components in the beamforming and translation module 218 is provided via the bus 1210.

The user interface 1204 allows for interaction between a user and the beamforming and translation module 218. The user interface 1204 may include a keypad, a keyboard, microphone, and/or speakers. The communication interface 1208 provides for two-way data communications from the beamforming and translation module 218. By way of example, the communication interface 1208 may be a digital subscriber line (DSL) card or modem, an integrated services digital network (ISDN) card, a cable modem, or a telephone modem to provide a data communication connection to a corresponding type of telephone line. As another example, communication interface 1208 may be a local area network (LAN) card (e.g., for Ethernet™ or an Asynchronous Transfer Model (ATM) network) to provide a data communication connection to a compatible LAN.

Further, the communication interface 1208 may also include peripheral interface devices, such as a Universal Serial Bus (USB) interface, a Personal Computer Memory Card International Association (PCMCIA) interface, and the like. The communication interface 1208 also allows the exchange of information across one or more wireless communication networks. Such networks may include cellular or short-range, such as IEEE 802.11 wireless local area networks (WLANS). And, the exchange of information may involve the transmission of radio frequency (FR) signals through an antenna (not shown).

Further, the above disclosure assumes the signal processing paths as being the Tx or Rx path of a transceiver device. It is noted that the present invention is not limited to such disclosure and the above disclosure may be easily modified to work in a system containing signal processing paths consisting of an electrical/electronic/optical measurements system that allows an information/measurement signal with or without modulating a carrier to be processed through it.

While an embodiment of the invention has been disclosed, numerous modifications and changes will occur to those skilled in the art to which this invention pertains. The claims annexed to and forming a part of this specification are intended to cover all such embodiments and changes as fall within the true spirit and scope of the present invention.

1. A digital integrated antenna array system comprising:
one or more antenna modules;
one or more transceiver modules each having one or more signal processing paths for transmitting data to or receiving data from said one or more antenna modules; and
a signal processing unit operable to process data for each of said one or more signal processing paths of said one or more transceiver modules such that the data transmitted from said one or more transceiver modules to the one or more antenna modules is radiated by said one or more antenna modules into one or more radiation patterns.

2. The digital integrated antenna array system of claim 1, wherein said one or more antenna modules each include columns or groups of passive antenna elements combined passively to achieve a predefined pattern.

3. The digital integrated antenna array system of claim 1, wherein the signal processing unit includes:
one or more digital interface modules operable to receive from one or more communication devices data to be transmitted to said one or more antenna modules, or to transmit to the one or more communication devices data that is received by said one or more antenna modules;
an frequency translation module operable to:
(1) receive from said one or more digital interface modules the data to be transmitted, perform frequency translation on the data to be transmitted, and transmit the data to be transmitted to said one or more transceiver module; or to
(2) receive from said one or more transceiver modules the received data, perform frequency translation on the received data, and transmit the received data to said one or more digital interface modules;
a beamforming module operable to apply beamforming weights to said one or more signal processing paths of said one or more transceiver modules; and
a dynamic calibration module operable to dynamically calibrate said one or more signal processing paths of said one or more transceiver modules by applying calibration weights to said one or more signal processing paths of said one or more transceiver modules.

4. The digital integrated antenna array system of claim 1, wherein each of the one or more transceiver modules includes one or more power amplifiers for transmitting the data to said one or more antenna modules.

5. The digital integrated antenna array system of claim 4, further comprising:
a power allocation module operable to equally allocate power to each of said power amplifiers of said one or more transceiver modules.

6. The digital integrated antenna array system of claim 4, further comprising:
a power allocation module operable to dynamically allocate power to each of said power amplifiers of said one or more transceiver modules such that the sum of the power allocated to each of said power amplifiers is equal to the total power allocated to all of said power amplifiers.

7. The digital integrated antenna array system of claim 4, further comprising:
a power allocation module operable to dynamically allocate power to each of said power amplifiers of said one or more transceiver modules such that each of the one or more radiation patterns radiated by said one or more antenna modules has the same EIRP.

8. The digital integrated antenna system of claim 7, wherein said power allocation unit is further operable to dynamically allocate power to each of said power amplifiers of said one or more transceiver modules such that the sum of the power allocated to each of said power amplifiers is equal to the total power allocated to all of said power amplifiers.

9. The digital integrated antenna array system of claim 3, wherein the one or more communication devices are further operable to transmit to said one or more digital interfaces, the beamforming weights used by said beamforming module.

10. The digital integrated antenna array system of claim 3, wherein server based software transmits to one of said one or more digital interfaces, the beamforming weights used by said beamforming module.

11. The digital integrated antenna array system of claim 1, wherein multiple operators provide data to be transmitted by said one or more transceivers to said one or more antenna modules and radiated by said one or more antenna modules in the one or more radiation patterns such that each operator provides data to be radiated in one or more radiation patterns, and one or more radiation patterns for one of the multiple operators overlaps one or more radiation patterns for another of the multiple operators.

12. The digital integrated antenna array system of claim 1, wherein the one or more radiation patterns are set according to a predetermined schedule.

13. The digital integrated antenna array system of claim 1, wherein the one or more radiation patterns are dynamically optimized in real-time.

14. The digital integrated antenna array system of claim 1, wherein the one or more radiation patterns are inputted by a user.

15. The digital integrated antenna array system of claim 4, further comprising:
an operation and maintenance module for collecting information relating to failure of said one or more transceiver devices or critical operating conditions of said one or more transceiver devices, and
wherein based on the information collected by said operation and maintenance module, said power allocation unit dynamically allocates power to each of said power amplifiers of said one or more transceiver modules, except each of said power amplifiers of said failed or critical operating transceivers, such that each of the one or more radiation patterns radiated by said one or more antenna modules has the same EIRP.

16. The digital integrated antenna array system of claim 15, wherein said power allocation unit is further operable to dynamically allocate power to each of said power amplifiers of said one or more transceiver modules, except each of said power amplifiers of said failed or critical operating transceivers, such that the sum of the power allocated to each of said power amplifiers, except each of said power amplifiers of said failed or critical operating transceivers, is equal to the total power allocated to all of said power amplifiers.

17. The digital integrated antenna array system of claim 4, further comprising:
an operation and maintenance module for collecting information relating to failure of said one or more transceiver devices or critical operating conditions of said one or more transceiver devices, and
wherein based on the information collected by said operation and maintenance module, said power allocation unit dynamically allocates power to each of said power amplifiers of said one or more transceiver modules, except each of said power amplifiers of said failed or critical operating transceivers, such that said power equally allocated to each of said power amplifiers of said one or more transceiver modules, except each of said power amplifiers of said failed or critical operating transceivers.

18. The digital integrated antenna array system of claim 4, further comprising:
an operation and maintenance module for collecting information relating to failure of said one or more transceiver devices or critical operating conditions of said one or more transceiver devices, and
wherein based on the information collected by said operation and maintenance module, said power allocation unit dynamically allocates power to each of said power amplifiers of said one or more transceiver modules, except each of said power amplifiers of said failed or critical operating transceivers, such that the sum of the power allocated to each of said power amplifiers, except each of said power amplifiers of the failed or critical operating transceivers, is equal to the total power allocated to all of said power amplifiers.

19. The digital integrated antenna array system of claim 1, wherein said one or more transceiver modules are configured for use in an n×n MIMO communication system, in which n is an integer.

20. The digital integrated antenna array system of claim 1, wherein said one or more transceiver modules are configured for use in a mixed MIMO and SISO communication system having multiple operators, such that at least one of the operators employs a MIMO communication system and at least one of the operators employs a SISO communication system.

21. The digital integrated antenna array system of claim 4, wherein a number of said one or more power amplifiers is equal to a number of said one or more signal processing paths for transmitting data.

22. A computer readable medium having a program recorded thereon that when executed by a computer causes the computer to control the digital integrated antenna array system of claim 1 via a method of controlling said one or more antenna modules, said method comprising:
providing one or more coverage areas for one or more service providers,
wherein the one or more coverage areas are provided according to a billing package subscribed to by the one or more service providers.
